(19) United States
(12) Patent Application Publication
(10) Pub. No.: US 2022/0180229 A1
(43) Pub. Date: Jun. 9, 2022

(54) DEFEASIBLE REASONING SYSTEM

(71) Applicant: Julian Ashton Plumley, Newcastle upon Tyne (GB)

(72) Inventor: Julian Ashton Plumley, Newcastle upon Tyne (GB)

(21) Appl. No.: 17/599,478

(22) PCT Filed: Apr. 1, 2020
(86) PCT No.: PCT/GB2020/050866

§ 371 Date: Sep. 28, 2021

(30) Foreign Application Priority Data
Apr. 2, 2019 (GB) 1904646.5

(51) Int. Cl. G06N 5/04; G06N 5/02

(52) U.S. Cl. CPC G06N 5/041; G06N 5/022

(57) ABSTRACT

A computing system for enabling a user to interact with graphical representations of defeasible reasoning. The system comprises a server device on which is running an application; memory storage on which is stored graph data defining a plurality of argument graphs, each argument graph comprising a plurality of nodes, said plurality of nodes comprising: at least a first premise statement node, connected via a first arc to at least a first argumentation scheme node, connected via a second arc to at least a first conclusion statement node, and optionally one or more evidence statement nodes connected via one or more arcs to the argumentation scheme node. The system further comprises at least one client device, wherein said application is operable to access the graph data and communicate at least part of the graph data to the client device.

### TECHNICAL FIELD

The present invention relates to computer systems enabling a user to interact with graphical representations of defeasible reasoning.

### BACKGROUND

Many techniques exist for expressing arguments and reasoning. Mathematical reasoning is expressed using algebra and formal logic is expressed using well established coding and syntax. Moreover, as mathematical reasoning and formal logic follow rules that tend to lead to absolute conclusions, such reasoning can easily be represented in a manner that can readily be integrated into computer systems.

However, even with advent of modern computing techniques which tend to generate outputs in terms of probabilities or quantified estimates, it is still difficult to represent so-called “defeasible” reasoning in a manner that can be readily quantified and integrated with computer systems.

Formally speaking, defeasible reasoning is reasoning that is rationally compelling, but not deductively valid. In a defeasible reasoning scheme, the truth of a premise provides support for the conclusion, even though it is possible for the premise to be true and the conclusion false. In other words, the relationship of support between a premise and conclusion is a tentative one, potentially defeated by additional information.

Defeasible reasoning closely approximates human reasoning, that is, the type of reasoning employed by human beings to assess arguments and reach conclusions.

Defeasible reasoning is often expressed in “long-form”, for example as essays, newspaper articles, in speeches by politicians etc. When expressed in such a manner, the soundness of an argument is often lost, or at least obscured, by rhetoric, hyperbole and appeals to reasoning that may sound compelling in the first instance, but with closer analysis can be seen to be weak, misleading or fallacious. Conventional techniques for expressing defeasible reasoning are difficult to formally analyse (for example with computer systems) because of the long-form format in which they are normally expressed.

### SUMMARY OF THE INVENTION

In accordance with a first aspect of the invention, there is provided a computing system for enabling a user to interact with graphical representations of defeasible reasoning. The system comprises a server device on which is running an application; memory storage on which is stored graph data defining a plurality of argument graphs, each argument graph comprising a plurality of nodes, said plurality of nodes comprising: at least a first premise statement node, connected via a first arc to at least a first argumentation scheme node, connected via a second arc to at least a first conclusion statement node, and optionally one or more evidence statement nodes connected via one or more arcs to the argumentation scheme node. The system further comprises at least one client device, wherein said application is operable to access the graph data and communicate at least part of the graph data to the client device.

Optionally, nodes of each argument graph are associated with at least one scenario space, each scenario space associated with an argument context.

Optionally, the graph data provides a single continuous graph space with which the plurality of argument graphs are associated.

Optionally, the application controls the client device to provide an interface configured to display argument graphs of the graph data enabling a user to view the graph data and modify the graph data by editing the graph data or generating new graph data.

Optionally, the interface is arranged to communicate modified graph data to the application which is arranged to store the modified graph data in the memory storage.

Optionally, the interface is configured to enable a user to modify the graph data by adding evidence statement nodes to an argument graph, said evidence statement nodes connected via an arc to at least one argumentation scheme node of the argument graph.

Optionally, the interface is configured to display the argument graphs on a display space corresponding to the continuous graph space such that scenario spaces are displayed in different regions of the graph space, and nodes associated with a scenario space are displayed within that scenario space.

Optionally, the argument graphs are interconnected via argument interconnecting arcs.

Optionally, the interface comprises a deduplication function configured to receive from a user new statement node data corresponding to a new premise statement node or a new conclusion node or a new evidence node; compare the new statement node data with statement node data of the graph data, and prevent the generation of new statement node data to the graph data in the event of a match.

Optionally, the free statement nodes of each argument graph are associated with a node score such that an evaluation score can be generated for each evaluated statement node, and an inference strength score can be generated for the argumentation scheme nodes, based on a combination of the node scores.

Optionally, the node scores of statement nodes can be amended by a user via the interface to generate locally on the client device an evaluation score for evaluated statement nodes specific to the user.

Optionally, the inference strength scores of argumentation scheme nodes are calculated using predetermined fixed values depending on the type of argumentation scheme used.

Optionally, the node scores and evaluation scores of statement nodes can be combined to generate an incoherence metric for the user's belief system.

Optionally, node scores, evaluation scores and inference strength scores are interpreted as probabilities, and the evaluation scores and inference strength scores are calculated using conditional probability tables.

Optionally, the web application further comprises a profiling function configured to collect node scores from different users and to generate profiling data for identifying users with similar views.

Optionally, the interface is configured to generate a three-dimensional view of the graph data.

Optionally, the interface is configured to optimise the layout of the graph data for the user to understand the argument.

Optionally, the interface is configured to maximise accessibility for all users by minimising the text labelling in the graph.

Optionally, argument graphs comprise at least one inference graph, each inference graph comprising at least a first premise statement node, connected via a first arc to at least a first argumentation scheme node, connected via a second arc to at least a first conclusion statement node, said interface further comprising a lessonising function configured to divide argument graphs comprising multiple inference graphs into one or more inference graphs and generate views of the argument graph in which one or more of the inference graphs are sequentially displayed.

Optionally, the interface includes a chatbot which provides an interactive communication service to the user during the sequential display of the inference graphs.

Optionally, the interface is configured to allow the user to learn interactively by changing node scores and by adding nodes to the argument graph and to store the results in the database.

Optionally, the interface is configured to provide an annotation function arranged to enable a user to annotate argument graphs displayed on the interface.

Optionally, the interface is configured to enable automated assessments of a user to be conducted.

Optionally, the web application further comprises a document writing application function configured to automatically generate a prose form of an argument represented by an argument graph.

Optionally, the web application further comprises a decision-making function configured to accept data for a value function from a user and generate an aggregate value metric from one or more argument graphs.

In accordance with a second aspect of the invention, there is provided an application for use in a computer system for enabling a user to interact with graphical representations of defeasible reasoning, said system comprising a server device on which is running an application; memory storage on which is stored graph data defining a plurality of argument graphs, each argument graph comprising a plurality of nodes, said plurality of nodes comprising: at least a first premise statement node, connected via a first arc to at least a first argumentation scheme node, connected via a second arc to at least a first conclusion statement node, and optionally one or more evidence statement nodes connected via one or more arcs to the argumentation scheme node, wherein said system further comprises at least one client device. The application is operable to access the graph data and communicate at least part of the graph data to the client device.

In accordance with certain examples of the invention, a technique is provided for representing defeasible reasoning. The technique represents defeasible reasoning in the format of a graph structure, comprising nodes and arcs, which can be readily stored and reproduced for interaction by one or more users of a computer system.

In certain examples, the technique enables a selection of nodes to be placed within a scenario space which is associated with an argument context. Advantageously, this means that the user can understand how the context affects the reasoning of the argument in an intuitive way. Further, in certain examples, the technique enables multiple argument graphs to be represented on a single continuous graph space, providing a single domain within which, potentially, all reasoning can be represented. Advantageously, this means that the way in which otherwise unconnected defeasible arguments are connected can be readily represented and understood.

In certain examples, nodes of argument graphs, particular premise statement nodes and evidence statement nodes can be given user-defined scores based on a user's perception of the truth of the associated statements. This enables evaluation scores for arguments to be generated on a user by user basis. Further, in certain examples, the inference strength scores of argumentation scheme nodes (defining argumentation scheme types) can be calculated using a fixed, predetermined score.

In this way, arguments employing the same argumentation scheme types are numerically evaluated in a consistent way, irrespective of the subject matter of the argument in question. Further, in certain examples, an incoherence measure can be defined using the node scores and evaluation scores which enables a “coherent” or “incoherent” judgement to be made for the user's belief system.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a schematic diagram of a system for implementing a argument graph generation technique in accordance with certain examples of the invention;

FIG. 2 provides a schematic diagram depicting the components of an inference graph in accordance with certain embodiments of the invention;

FIG. 3 provides a schematic diagram depicting the concept of an argumentation scheme template for the argumentation scheme of “expert opinion”;

FIG. 4a provides a schematic diagram depicting an example of completed inference graph based on the argumentation scheme template of FIG. 3;

FIG. 4b provides a schematic diagram of the inference graph described with reference to FIG. 4a but in which the inference graph has been modified to include a further evidence statement node;

FIG. 5 provides a schematic diagram depicting the example inference graph for the argumentation scheme “expert opinion” comprising a first and second critical question;

FIG. 6 provides a schematic diagram of an inference graph corresponding to that described with reference to FIG. 4b except that an additional evidence statement node is shown;

FIG. 7 depicts an argument graph comprising the graphs of four connected inferences;

FIG. 8 provides a schematic diagram corresponding to the argument graph shown in FIG. 7 and in which further reasoning is added, depicting an example in which the argument graph is branched via a new evidence statement node and via a rebuttal;

FIG. 9a provides a diagram of three separate argument graphs and FIG. 9b shows the corresponding arguments shown on a single graph space;

FIG. 10 provides a schematic diagram depicting an argument graph that can be generated and displayed on a graph interface in accordance with embodiments of the invention that uses a scenario space named “Violinist in a coma.”;

FIG. 11 provides a schematic diagram of a system according to certain embodiments of the invention comprising multiple client devices;

FIG. 12 provides a schematic diagram of a deduplication process in accordance with certain embodiments of the invention;

FIG. 14 provides a schematic diagram of a web application including a profiling function in accordance with certain embodiments of the invention;

FIGS. 15a to 15k provide diagrams of a number of truth tables in accordance with certain embodiments of the invention, and

FIGS. 16a to 16k, FIG. 17, FIG. 18 and FIG. 19 provide diagrams of a number of conditional probability tables in accordance with certain embodiments of the invention.

### DETAILED DESCRIPTION

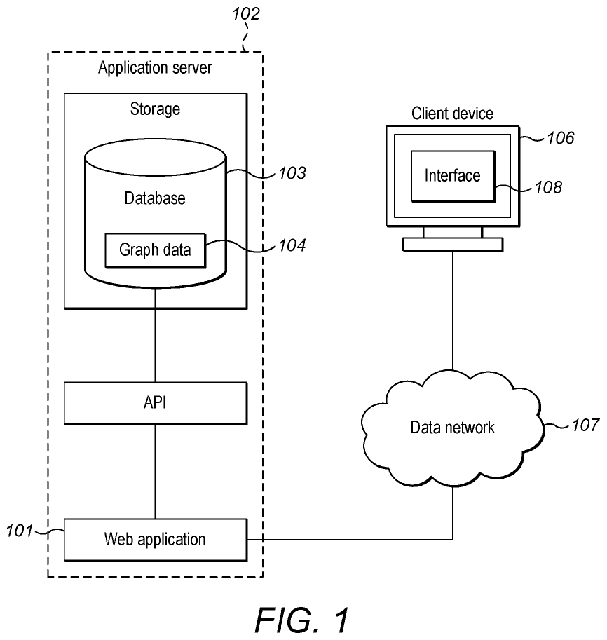

FIG. 1 provides a schematic diagram of a system for implementing an argument graph generation technique in accordance with certain examples of the invention.

The system comprises a web application 101 running on an application server 102. The application server 102 further comprises a database 103 on which is stored graph data 104 which the web application 101 accesses via an application programming interface (105) 105. The web application 101 is connected to a client device 106 via a data network 107. The client device 106 has running there on a browser application providing an interface 108 which is displayed on a display of the client device 106.

The web application 101 is configured to provide graph display information to the browser application for generating the interface 108 displayed on the display of the client device 106 and with which a user can interact. Typically, the interface 108 is in the form of a web interface which enables information in the form of text and graphical objects etc to be displayed on a display on the client device. The web interface typically provides user controls allowing a user to manipulate the display of graphical objects on the interface, along with means to input user data such as to add text, edit/modify existing text, add graphical elements (for example nodes and arcs as described in more detail below) or edit/modify existing graphical elements such as nodes and arcs.

The system is configured to enable a user to interact with (e.g. generate, view and manipulate) graphical representations of defeasible human reasoning.

The web browser application can be provided by any suitable conventional web browser as is known in the art.

The web application 101 comprises software configured specially to control operation of the system. In particular, in certain embodiments, the web application 101 provides the functionality for controlling the interface 108 displayed on the client device 106 in particular the display of graph data.

The web application 101 receives graph data from the interface 108 (for example relating to modified graph data or newly generated graph data as described in more detail below) and controls, via the API 105, the database 103 and updating of the graph data stored in the database 103.

The API 105 typically comprises software configured specially to control the way in which graph data is sent to the database 103 and retrieved from the database 103 by the web application 101.

The client device 106 is typically provided by a suitable personal computing device such as a personal computer, tablet, smartphone, smart TV, games console or similar. Such computing devices comprise a display, user input means (for example a touchscreen, keyboard, mouse etc), memory, a processor and a data input/output means for communicating data to and from the data network. Such data input/output means are well known in the art and include, for example, physical ethernet connections, wireless connections such as WiFi, Bluetooth and so on.

The application server 102 on which is running the web application, API and database can be provided by any suitable server computer as is well known in the art. The application server 102 can be provided by a single physical server computing device or functionality associated with the application server can be distributed across two or more physical server devices using distributed computing techniques as is well known in the art.

In FIG. 1, the database 103, API 105 and web application 101 are shown running on the same application server 102. However, in other embodiments, the database 103, API 105 and web application 101 may be run on different physical application servers.

In certain embodiments, as described above the functionality provided by the interface 108 is typically implemented by the web application running 101 on the application server and any implementation of the functionality of the interface 108 on the browser application is minimised. However, in other embodiments, implementation of the functionality of the interface 108 is divided between the web application running on the application and parts of the web application running on the client device 106. In certain such embodiments some, most or all of the implementation of the functionality associated with the interface 108 is implemented by parts of the web application running on the client device 106.

The data network 107 is typically provided by the internet. Components of the data network may be provided by other networks such as cellular telephone networks, particularly if the client device is a computing device such as a smartphone.

In accordance with certain embodiments of the invention, the interface 108 provides a means for a user to generate graph-based representations of defeasible reasoning. Specifically, the interface enables a user to generate one or more argument graphs. Each argument graph comprises one or more connected inference graphs. The graphs are displayed on a display space of the interface.

An inference graph represents a defeasible inference. An inference graph comprises at least one premise statement, one argumentation scheme and one conclusion statement.

Correspondingly, in accordance with embodiments of the invention, an inference graph comprises at least one premise statement node representing a premise statement; an argumentation scheme node representing an argumentation scheme; and a conclusion statement node representing a conclusion statement. The components of an inference graph are connected by arcs. A premise arc connecting a premise node to an argumentation scheme node represents the logical relation of a statement being a premise of an inference. A conclusion arc connecting an argumentation scheme node to a conclusion node represents the logical relation of a statement being a conclusion of an inference. Arcs are “directed” (e.g. with an arrow) which show the direction in which the reasoning flows, e.g. from premises to the conclusion.

An inference is “pro” if it tends to make a conclusion true or “con” if it tends to make the conclusion false. In certain examples, the display of inference graphs on the graph interface is adapted so that conclusion arcs are labelled “conclusion-pro” and “conclusion-con”. Alternatively or additionally, argumentation scheme nodes can be labelled as pro or con.

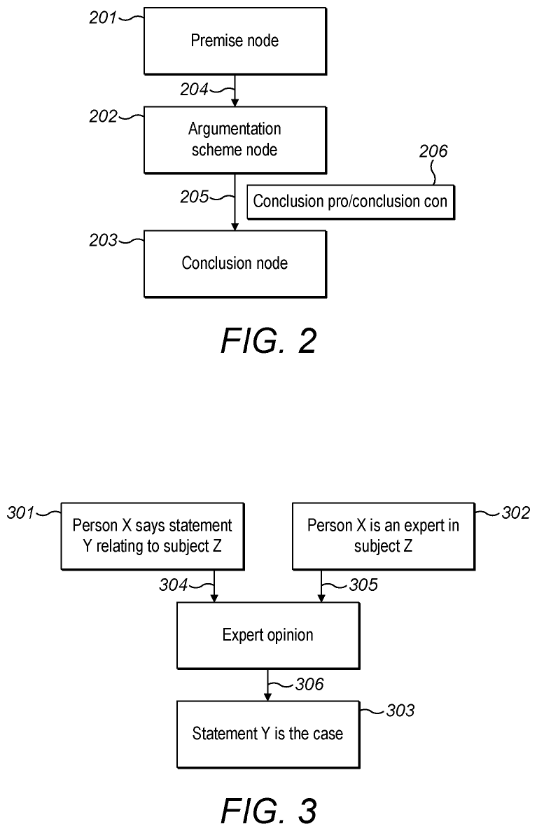

FIG. 2 provides a schematic diagram depicting the components of an inference graph in accordance with certain embodiments of the invention. As shown in FIG. 2, the inference graph components comprise a first statement node in the form of a premise statement node 201, an argumentation scheme node 202, a second statement node in the form of a conclusion statement node 203, a premise arc 204 connecting the premise statement node 201 to the argumentation scheme node 202, a conclusion arc 205 connecting the argumentation scheme node 202 to the conclusion statement node 203, and a conclusion arc label 206 comprising label data that labels the conclusion statement node arc as either conclusion pro or conclusion con.

As described above, each inference graph comprises an argumentation scheme node corresponding to a particular “argumentation scheme”.

Each argumentation scheme corresponds to a type of inference that humans use in reasoning. Argumentation schemes capture common sense patterns of reasoning that humans use in everyday discourse. Examples of argumentation schemes are: “value”, “rule”, “best explanation” and so on. Generally, there is no definitive list of argumentation schemes. Definitions from different authors can differ to some extent. For example, the “popular opinion” argumentation scheme can be treated as one argumentation scheme, or it can be split into several argumentation schemes that cover different aspects of this type of reasoning: e.g. “snob appeal”, “appeal to vanity”, “rhetoric of belonging”, and so on.

However, the system provides a plurality of predefined argumentation schemes, each defined by an argumentation scheme template. The argumentation scheme template defines the format of the inference graph for that particular type of argumentation scheme. Specifically, the argumentation scheme template defines the number of premise statements required for an argumentation scheme of that type, and the format of the premises. FIG. 3 illustrates the concept of an argumentation scheme template for the argumentation scheme of “expert opinion”.

As can be seen from FIG. 3, this argumentation scheme template comprises a first premise statement field 301 of the form: “Person X says statement Y relating to subject Z” and a second premise statement field 302 of the form “Person X is an expert in subject Z”. Both these premise statements are connected via first and second directed arcs 304, 305 to the argumentation scheme node. The argumentation scheme node is connected via a directed arc 306 to the conclusion statement node field 303 of the form “Statement Y is the case.”

### Inference Graph Generation

To generate an inference graph, the interface first prompts a user to select an argumentation template. Once this is done, the interface prompts the user to populate the premise statement nodes of the inference graph and the conclusion statement node and, where appropriate, to classify the conclusion arc to generate an appropriate conclusion arc label.

Optionally, a blank argumentation scheme template can be used to generate an inference graph. The blank argumentation scheme node does not specify the type of inference. The user can create and populate premise statement nodes and a conclusion statement node as necessary and, where appropriate, to classify the conclusion arc to generate an appropriate conclusion arc label. Blank argumentation schemes can be useful for the user in constructing an argument graph. For example, a blank argumentation scheme can act as a placeholder if the user wants to create the inference but has not yet decided which argumentation scheme to use. An argumentation template can be applied to the argumentation scheme node later.

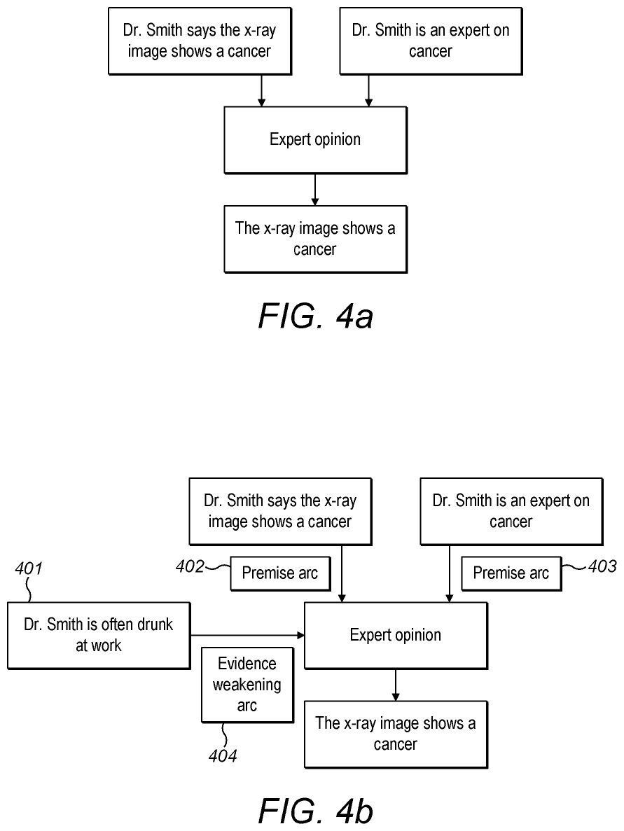

FIG. 4a provides a schematic diagram depicting an example of completed inference graph based on the argumentation scheme template described with reference to FIG. 3.

### Inference Graph Modification

In certain examples, the interface enables a user to modify an inference graph by adding further evidence statement nodes that represent evidence statements that may strengthen or weaken the inference. An evidence arc connecting an evidence statement node to an argumentation scheme node represents the logical relation of a statement strengthening or weakening (defeating) an inference. For example, the statement “Dr. Smith is often drunk at work.” could plausibly weaken the inference described with reference to FIG. 4a.

FIG. 4b provides a schematic diagram of the inference graph described with reference to FIG. 4a but in which the inference graph has been modified to include a further evidence statement node 401. As can be seen in FIG. 4b, in certain examples, the interface is arranged to add label data 402, 403 (e.g. “premise arc”) to arcs connecting premise statement nodes that are required to make an inference work (e.g. specified in an argumentation scheme template) and to add label data (for example label data 404) to arcs connecting subsequently added evidence statement nodes that enable a user to specify whether the additional evidence statement node strengthens or weakens the inference (e.g. “evidence-strengthening arc” or “evidence-weakening arc”).

### Critical Questions

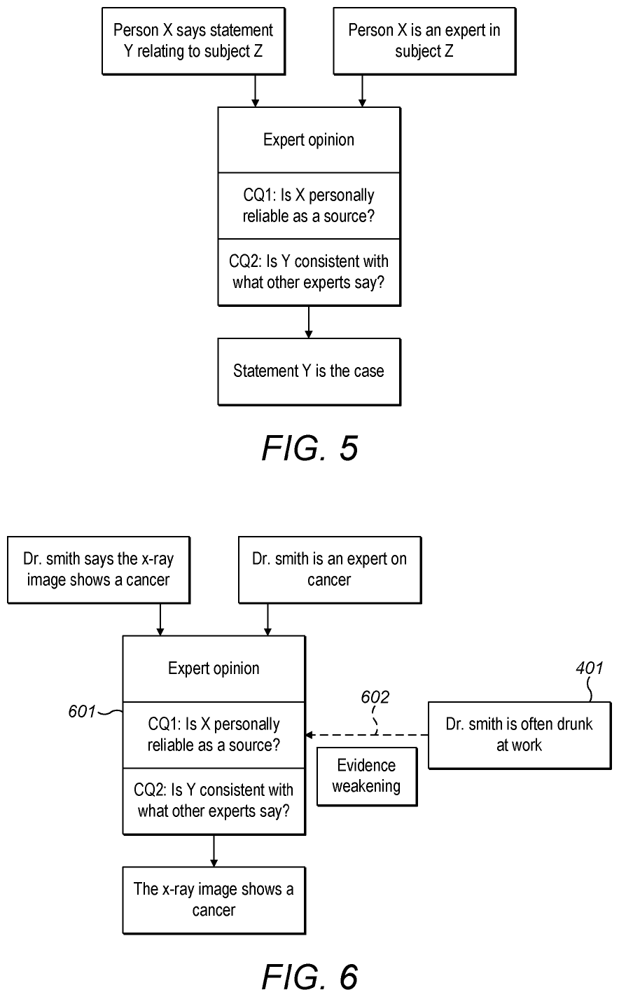

In certain examples, the argumentation scheme template may specify one or more critical questions relating to the argumentation scheme to which the argumentation scheme template relates. Critical questions are questions that are meant to elicit ways in which an inference may be weakened or strengthened by further evidence. The critical questions are a help to the user, to think about how the inference may be modified by further evidence. Such critical questions can be depicted by additional labelling on the argumentation scheme node in question. FIG. 5 provides a schematic diagram depicting the argumentation scheme template for the argumentation scheme of “expert opinion” comprising a first and second critical question.

In certain examples, the interface enables a user to associate evidence statement nodes with one of the critical questions via an arc.

This concept is depicted in FIG. 6. FIG. 6 provides a schematic diagram of an inference graph corresponding to that described with reference to FIG. 4b except that an additional evidence statement node 401 specifying “Dr. Smith is often drunk at work” is shown which is connected to the relevant critical question 601 via an evidence weakening arc 602.

### Argument Graph Generation

An argument is a series of one or more connected inferences leading to a final conclusion statement. An argument is represented by an argument graph.

As described above, the interface enables a user to connect a number of inference graphs together to generate an argument graph.

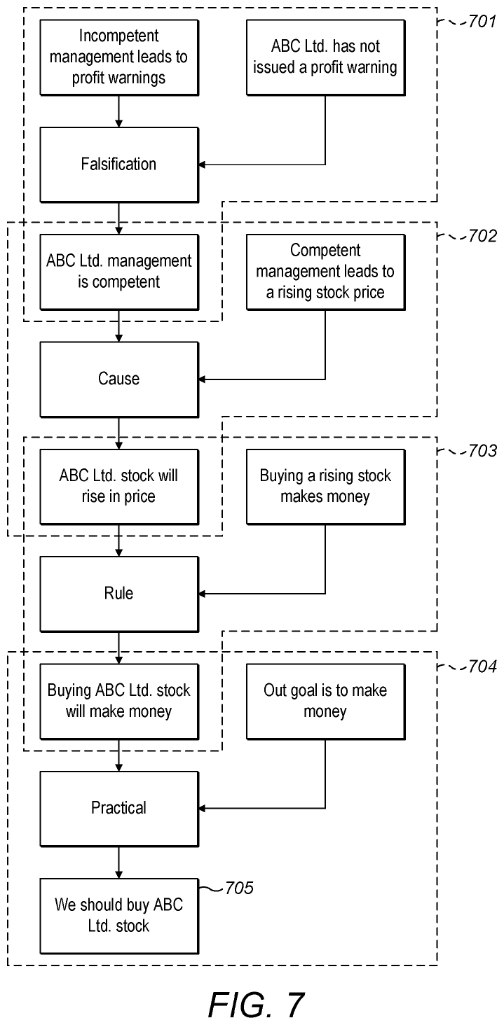

FIG. 7 provides a schematic diagram depicting this concept. FIG. 7 depicts an argument graph comprising four connected inference graphs 701, 702, 703, 704 which terminate in a final conclusion statement node 705. (The dotted lines in the diagrams are merely to pick out the different inference graphs and are not part of the graph.)

The inference graphs overlap when they share a statement node. The same statement node can be an premise statement node for a set of one or more inference graphs, a conclusion statement node for a different set of one or more inference graphs, and an evidence statement node for another different set of one or more inference graphs. For example, as can be seen in FIG. 7, the statement node specifying “ABC Ltd. management is competent.” is a conclusion statement node with respect to inference 701 and a premise statement node with respect to inference 702.

An argument graph can be linear, or it can be branched.

The argument graph depicted in FIG. 7 is linear, since the conclusion statement node of each inference is a premise statement node of the following inference. In general, argument graphs can be branched, and it is normal for argument graphs to branch as more reasoning is applied to the case.

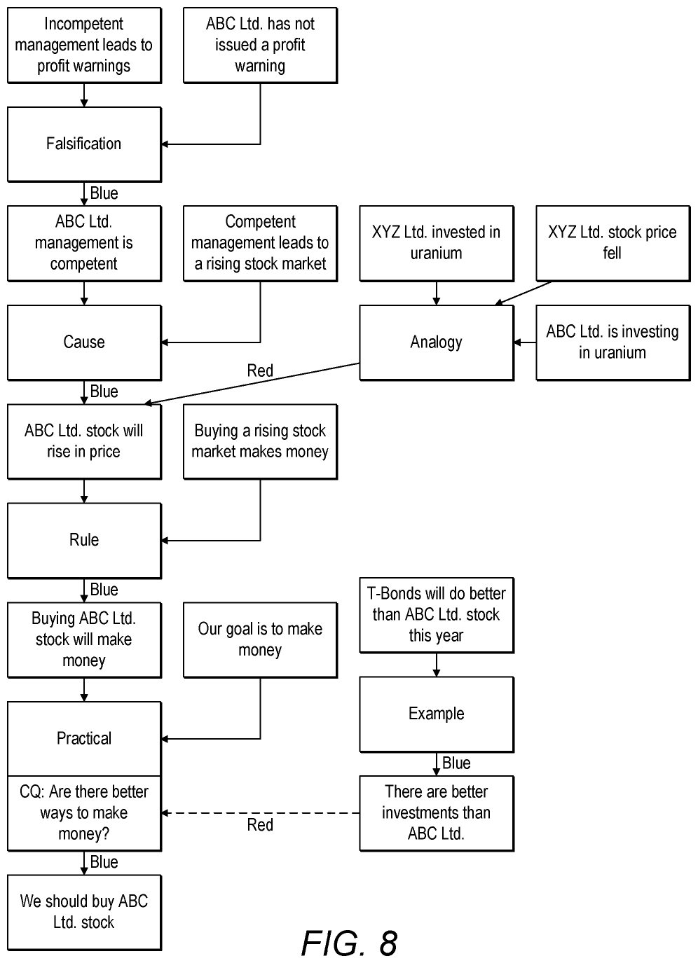

FIG. 8 provides a schematic diagram corresponding to the argument graph shown in FIG. 7 and in which further reasoning is added, depicting an example in which the argument graph is branched via a new evidence statement node and via a rebuttal. In FIG. 7 conclusion-pro arcs are shown in solid blue, conclusion-con arcs in solid red and evidence-weakening arcs in dashed red.

In this example, the statement node specifying “There are better investments than ABC Ltd.” is the conclusion statement node of a new inference graph, and is also a new evidence statement node connected to a critical question of the “Practical” argumentation scheme node. In addition, the statement node labelled “ABC Ltd. stock will rise in price” is the conclusion statement node of another new inference graph connected via a conclusion-con arc. This situation where a pro inference and a con inference have the same conclusion statement is called a rebuttal.

As described above, argumentation schemes are normally used for defeasible reasoning. However, in certain examples, deductive reasoning can also be accommodated in an argument graph.

Argumentation scheme templates can be devised for rules of deductive reasoning such as modus ponens or disjunctive syllogism. Alternatively, some of the defeasible argumentation schemes can do the work of a deductive inference: for example, an inference including an “alternatives” argumentation scheme that is not modified by any evidence statement is equivalent to an inference using disjunctive syllogism.

### Graph Space

The interface enables a user to generate different argument graphs on a single continuous graph space. In this way, connections can be made between different argument graphs to reveal how different arguments are related and interact with each other. The single graph space provided by the interface enables a user to join up these graphs to form a set of interconnected argument graphs using argument interconnecting arcs.

For example, the statement node specified by “God exists” may exist in several different argument graphs. It might be the final conclusion statement node of one argument graph, a premise statement node of another argument graph and an evidence statement node connected via an arc to a critical question in another argument graph. Accordingly, these argument graphs could be represented separately or could be linked in a single graph space, sharing this statement node. The argument interconnecting arcs are the arcs that link to this statement node in the several different argument graphs.

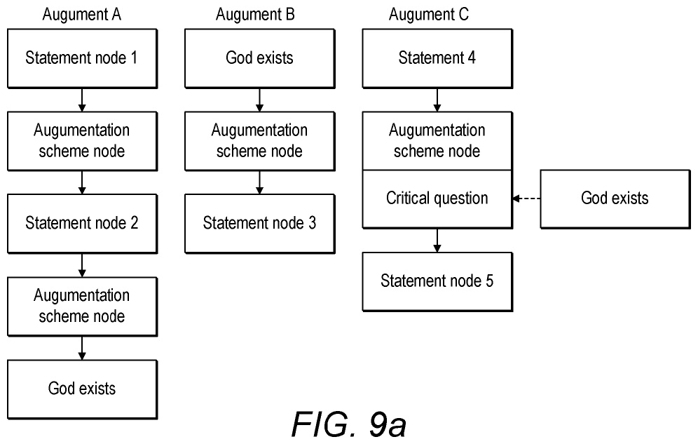

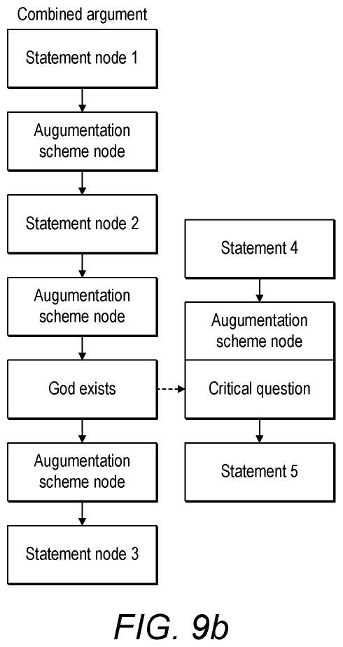

This concept is explained with reference to FIG. 9a and FIG. 9b. FIG. 9a provides a diagram of three separate argument graphs—A, B & C—each of which includes a statement node specified by “God exists.” The statement node specified by “God exists” is the final conclusion statement node of argument graph A, a premise statement node in argument graph B and an evidence statement node in argument graph C. FIG. 9b provides an example graph space corresponding to that shown in FIG. 9a except the argument graphs are implemented within one graph space. As can be seen, the statement node specified by “God exists” only occurs once. It is now in the middle of a branched chain of reasoning combining arguments A, B and C. The original three argument graphs are interconnected by the arcs which link to the shared statement node specified by “God exists.”

### Scenario Space

The reasoning associated with certain arguments graphs may be dependent on particular special argument contexts which do not apply to the reasoning associated with other argument graphs. Such argument contexts can be of several types, including counterfactual past, possible future, fiction, thought experiment, and so on. The same statement within a given argument context may have a different truth-value when understood as being outside that argument context. For example, the statement “Magical spells are effective.” might be true in a fictional argument context, but false outside of that argument context.

In accordance with certain embodiments of the invention, to accommodate this, the interface enables a user to specify, within the graph space, certain “scenario spaces”. Nodes of inference graphs and argument graphs within such scenario spaces are affected by the argument context to which that scenario space relates and nodes of inference graphs and argument graphs outside of that scenario space are not. This concept is further explained with reference to FIG. 10.

FIG. 10 provides a schematic diagram depicting an argument graph that can be generated and displayed on a graph interface in accordance with embodiments of the invention that uses a scenario space named “Violinist in a coma.” that represents a thought experiment. (Taken from Thomson, J. “A Defense of Abortion”. Philosophy and Public Affairs 1:1 (Autumn 1971): 47-66.)

Most of the nodes of the argument graph are within this scenario space.

Advantageously, rather than using additional text to label each node with the name of the scenario space, the scenario space is represented by a particular region of the graph.

The boundary of this region (shown with a dot-dashed line) encloses the nodes that are within this scenario space. The nodes outside this region are outside this scenario space.

As described above, the interface enables a user to generate multiple argument graphs on the same graph space. Optionally, the single graph space can include all of the scenario spaces. In this case, two statement nodes specified by the same text are identical if the are within the same scenario space, or if they are both outside any scenario space. But they are not identical if they are within different scenario spaces, or if one is within a scenario space and the other is not. For example, a statement node specified by “Magical spells are effective” within a fictional scenario space defined by the “Harry Potter” books is not identical to a statement node specified by “Magical spells are effective” outside of that scenario space. As explained above, two argument graphs that include the same statement node can be interconnected, but not if that statement node is within a certain scenario space in one argument graph, but not in the other argument graph, because such statement nodes are not identical.

### Generating Graph Data

As described above, the interface provides a means for a user to generate graph-based representations of defeasible reasoning comprising argument graphs constituted by one or more inference graphs. The graphs generated by a user are generated by the interface as graph data. Once generated, the graph data is communicated from the client device to the database where it is stored. This enables a user to store graphs that they have generated and retrieve them for viewing, editing and adding further graphs.

Typically, the system described with reference to FIG. 1, supports multiple users. This is depicted schematically in FIG. 11 which shows a plurality of client devices, each providing an interface enabling a user to generate graph-based representations of defeasible reasoning. In certain examples, the system enables multiple users to access the same graph data so that multiple users can view, edit and add further graphs. In particular, in examples where the graph data corresponds to a single continuous graph space, multiple different users can access, edit and add further graphs to this single continuous graph space.

### De-Duplication

In examples where multiple users are able to add graph data to a single continuous graph space, it is advantageous to avoid the duplication of statement nodes so that the same inference graph and/or argument graph are not separately created.

Deduplication is easy to do when statements are identical. But statements can be expressed in different ways and have the same logical meaning. For example, the statement “It is never morally justified to terminate a pregnancy” has the same meaning as the statement “Killing an unborn child is morally wrong”. It is also necessary to avoid duplication of such statements with the same meaning but expressed in different ways.

In order to reduce the chance of statement nodes being duplicated, in accordance with certain examples of the invention, the interface is provided with a deduplication function configured to perform a duplication function every time a user adds a new statement node to the graph data. The deduplication function receives input statement text data from a user, parses the statement text data, generates meaning data corresponding to the meaning of the input statement text and compares the meaning data to similarly generated meaning data generated for every other statement node of the graph data. The meaning data for the existing statement nodes is typically stored in the database 103. If deduplication function determines that there are no matches, then the interface permits the creation of the statement node. If the deduplication function determines that there is a match or a possible match, then the interface either prevents the creation of the new statement node, or requests the user to confirm that the statement node is not the same as the existing statement node for which a possible match has been identified.

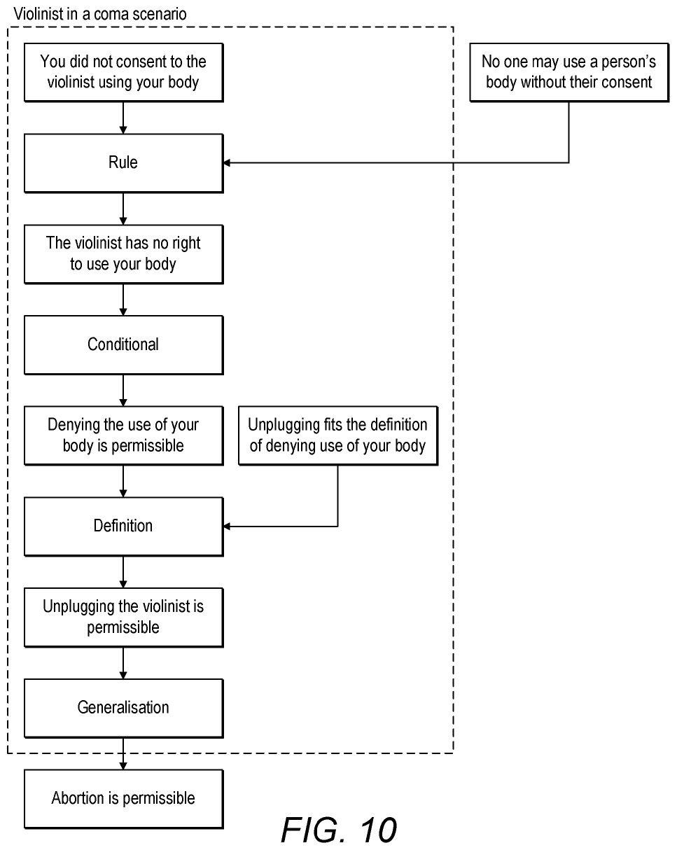

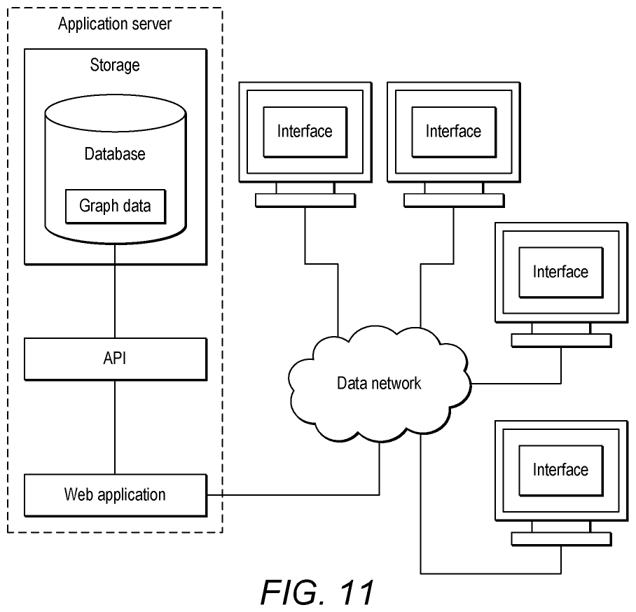

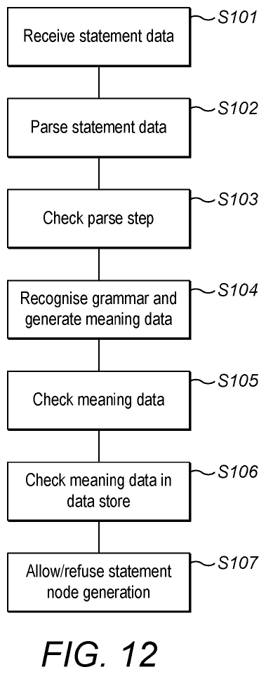

FIG. 12 provides a schematic diagram depicting an example of a deduplication process performed by a deduplication function of the interface in accordance with certain embodiments of the invention.

At a first step S101 the interface receives statement data from a user. For example, “It is never morally justified to terminate a pregnancy”.

At a second step S102, a parse operation is performed where a text recognition process are used to attempt to identify the key terms used in the statement, known as resources.

For example, during the parse operation the text recognition processes may identify the resources as: “terminate a pregnancy”=abortion; “is”=has property; and “never morally justified”=morally impermissible.

At a third step S103; the result of the parse operation is presented to the user to confirm that the parse operation has correctly identified the resources used in the statement data.

Optionally, the parse step can use outside references to fix the referent of each resource; this process is known as dereferencing. Dereferencing is well known in the art for linked data models. URIs (Uniform Resource Identifiers) are typically used with a form similar to web addresses. Dereferencing gives a link to further information that identifies a resource unambiguously, thus allowing ambiguously named referents to be distinguished. For example, “London” might refer to a city in England or in Canada. The parsing operation can distinguish between these different referents of “London” by using the URIs https://wikipedia.org/wiki/London for the city in England and https://wikipedia.org/wiki/London Ontario for the city in Canada. The URIs can then be used to tag the resources during the parsing operation so that the user can check if they refer to the right thing.

A further advantage of using external resources such as URIs for dereferencing resources is that they are language-independent. This allows the parsing process to work across languages and to check for statements with the same meaning which have been written in different languages.

In the event that the user confirms that the parse step has correctly identified the referents used in the statement data, a fourth step S104 is performed in which a grammar recognising process attempts to determine the meaning of the statement data by correctly interpreting the grammar of the statement data. For example, in the fourth step, the grammar recognising process may determine the statement data has the grammatical structure subject+predicate+object, with subject=“abortion”, predicate=“has property” and object=“morally impermissible”. So the statement has the meaning of: abortion has property morally impermissible.

At a fifth step S105, the meaning data determined during the further step S104 is presented to the user to confirm that the grammar recognising process has correctly interpreted the meaning of the statement data.

In the event that the user confirms that the grammar recognising process has correctly interpreted the meaning of the statement data, at a sixth step S106 the meaning data generated during the fourth step S104 is communicated to the database where a search process is conducted to identify meaning data associated with any existing statement nodes that corresponds with the meaning data generated during the further step.

In the event that the search process identifies corresponding meaning data relating to an existing statement node, the search process communicates a “match found” message to the deduplication function and at a seventh step S107, the interface prevents the creation of the new statement node. In the event that the search process does not identify corresponding meaning data relating to an existing statement node, the search process communicates a “no match found” message to the deduplication function and at the seventh step S107, the interface allows the creation of the new statement node.

Optionally, the meaning data for each statement node can be stored using a recognised semantic code which can convey meaning to external computer systems. This allows data to be transferred to and exchanged with clients in a convenient way. One such recognised standard is the RDF (Resource Description Framework) specification, which is used for knowledge management. The RDF data model allows statements to be made about resources in expressions of the form subject-predicate-object, known as “triples”.

In certain embodiments, the deduplication function is configured to automatically search for existing statement nodes specified by similar key words to the new statement node to be added. A list of matched statement nodes is presented to the user who is adding the new statement node to decide if there is duplication. The user then can choose to add the new statement node, or to use an existing statement node.

In order to represent reasoning in the most comprehensive and objective way, it is an advantage to use simple statements. Complicated statements may hide parts of an inference that would be better represented explicitly in the graph space. For example, a compound statement such as “London is in England and it is a huge city” is preferably split into two statements. The deduplication process will also detect if the grammatical structure of a statement is very complicated, and this will be a further reason for rejection.

### Semantic Tagging

The process of detecting the grammatical structure of a statement and identifying and then dereferencing its resources is sufficient to define a precise and unambiguous meaning for that statement.

Argument graphs in accordance with certain embodiments of the invention include semantic tagging, in which a semantic tag comprising the meaning data for the statement is associated with the statement nodes. In certain embodiments, the interface comprises functionality that allows a given statement to be located in the graph space and all reasoning that includes the statement can be discovered and displayed.

For example, if a user types the statement “God exists” or “There is a God” or the question “Does God exist?” or “Is there a God?” into the interface, the parsing operation can be used to return the meaning data “God has property existence.” The statement or question is then interpreted as a request to find the statement node with that meaning data and all reasoning that pertains to it.

### Score Generation and Evaluation

As described above, in accordance with certain examples of the invention, a user can generate argument graphs comprising one or more inference graphs to represent defeasible reasoning.

In certain examples, certain nodes of these graphs can be associated with a node score. These scores can be combined to generate an overall evaluation score for an argument graph. The overall evaluation score can be used as a metric for the confidence of the correctness of the final conclusion statement of the argument graph.

In certain examples, the interface is provided with a score generation function that is configured to permit a user to edit the node score for each statement node that is not the conclusion statement node of any inference graph comprising the argument graph. These are known as free statement nodes. The argument graph can then be evaluated using these node scores.

An evaluation function calculates an inference strength score for each argumentation scheme node. The evaluation function also calculates an evaluation score for each statement node that is the conclusion statement of any inference graph comprising the argument graph. These are known as evaluated statement nodes. The evaluation score for the final conclusion statement node is the overall evaluation score.

For example, the score generation function can be arranged to enable a user to select a node score for each free statement node of either “True” corresponding to the user's belief that the statement is true, or “False” corresponding to the user's belief that that the statement is false, or “Undetermined” corresponding to the user's belief that the truth or falsity of the statement is unknown. The evaluation function then calculates an inference strength score of “Strong” or “Weak” for each argumentation scheme node. The evaluation function also calculates an evaluation score of “True” or “False” or “Undetermined” for each evaluated statement node.

In accordance with certain embodiments, the evaluation calculation can be performed with truth tables. The inference strength score for an argumentation scheme node is calculated from the node scores (for free statement nodes) and evaluation scores (for evaluated statement nodes) of the statement nodes connected to it by premise arcs and evidence arcs. The evaluation score for a statement node is calculated from the inference strength scores of the argumentation scheme nodes connected to it by conclusion arcs. The calculations are made using a truth table. The rows of a truth table show all possible score combinations of the nodes which affect the score of the node in question. The truth tables embody the calculation rules of the evaluation function.

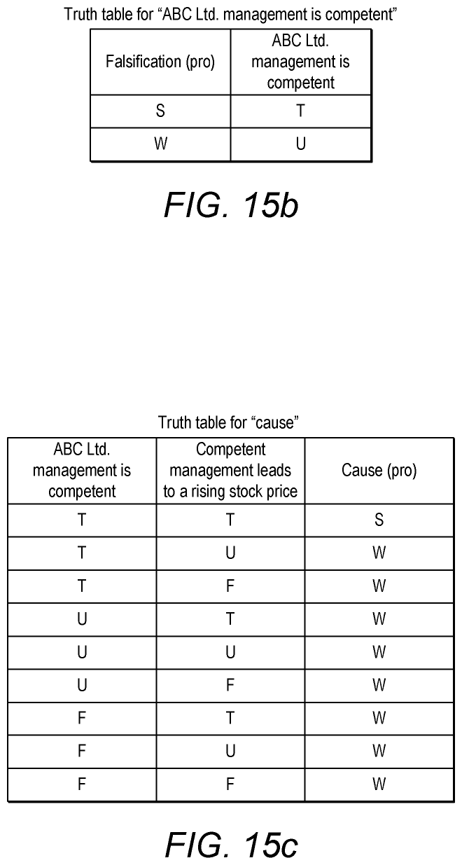

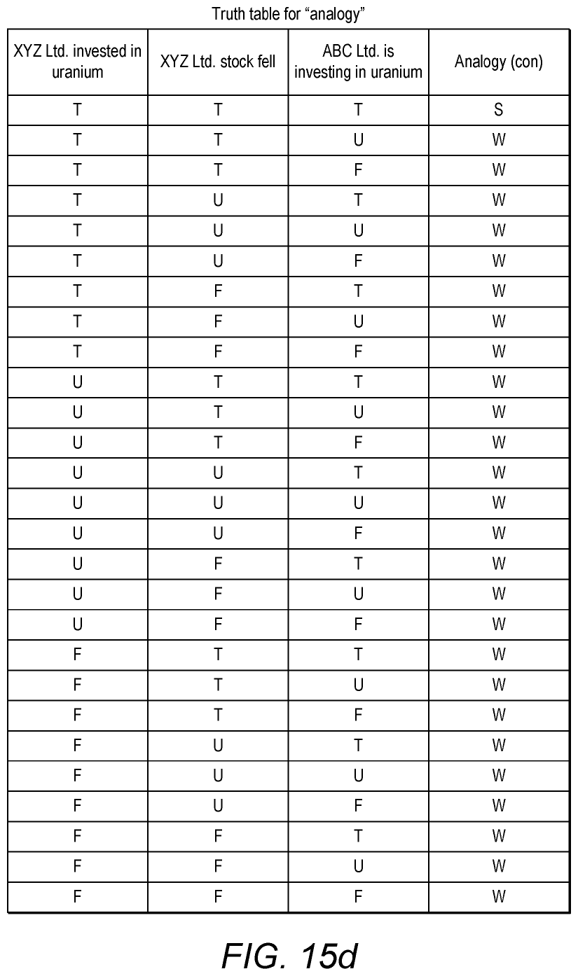

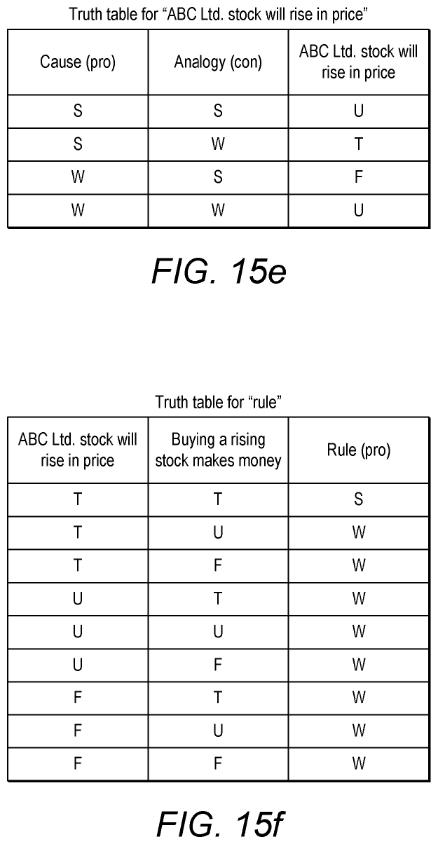

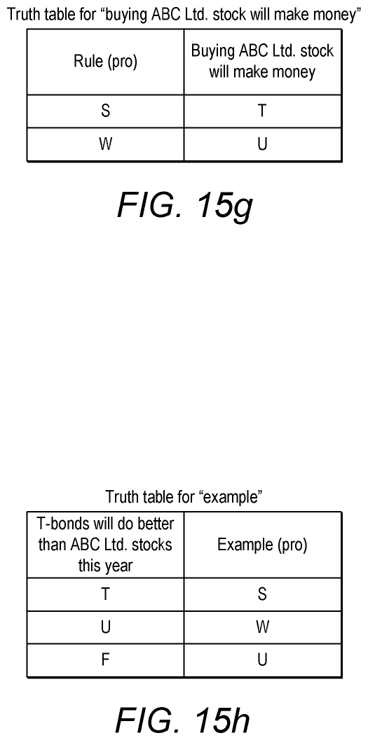

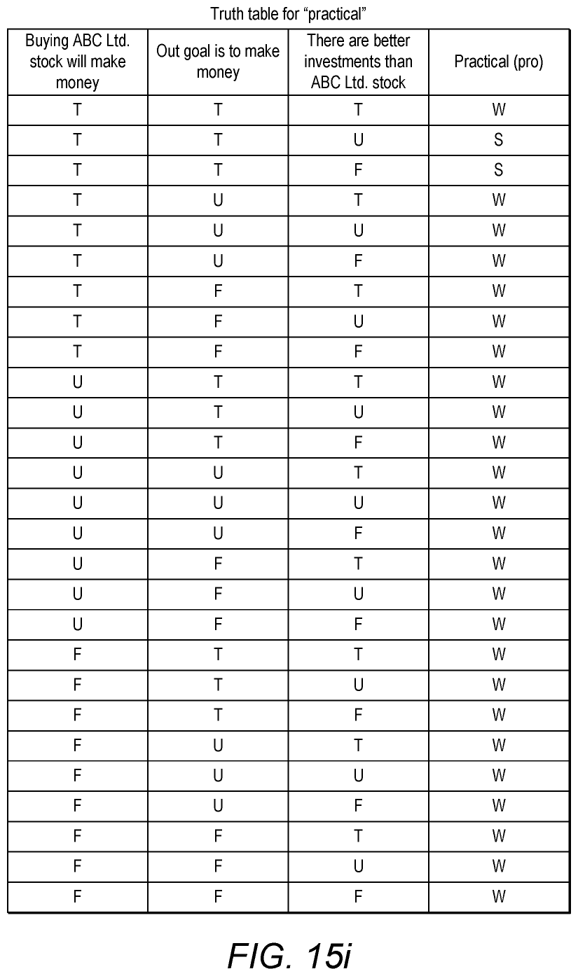

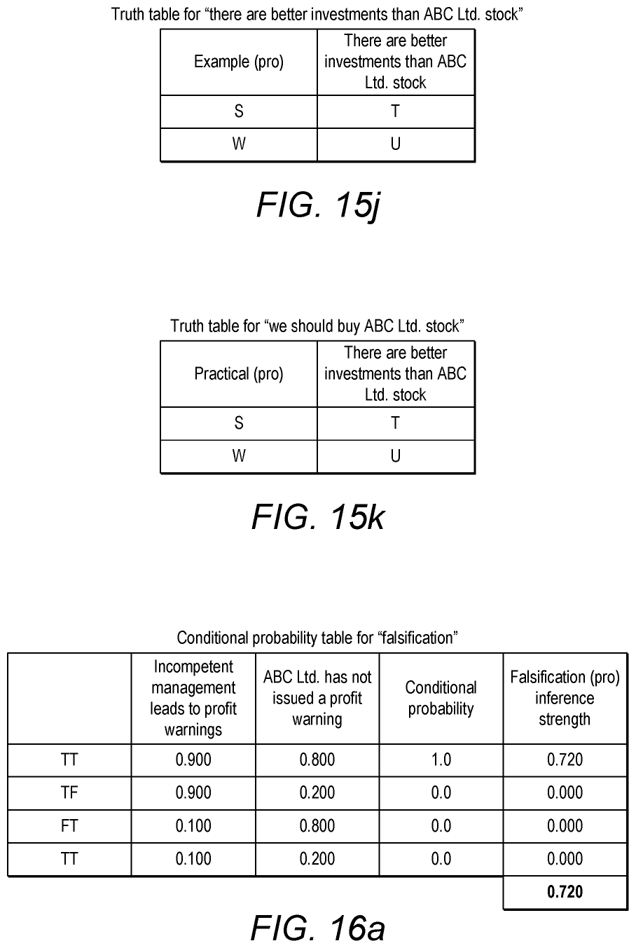

FIG. 15(a-k) shows a set of such truth tables corresponding to the argument graph of FIG. 8. In FIG. 15 S=Strong, W=Weak, T=True, U=Undetermined, F=False. These tables incorporate the following calculation rules:

For an argumentation scheme node, the inference strength score “strong” if all its premise statement nodes are scored as “True” and no weakening evidence node is scored as “True”; otherwise it is scored as “Weak”.

For an evaluated statement node, the evaluation score is “True” if any argumentation scheme node connected to it by a conclusion-pro arc is scored as “Strong” and no argumentation scheme node connected to it by a conclusion-con arc is scored as “Strong”. It is scored as “False” if any argumentation scheme node connected to it by a conclusion-con arc is scored as “Strong” and no argumentation scheme node connected to it by a conclusion-pro arc is scored as “Strong”. Otherwise it is scored as “Undetermined”.

The evaluation function calculation starts from the node scores chosen by the user for the free statement nodes of the first inference graph in the argument graph, using the first table (FIG. 15a) to look up the inference strength score for the argumentation scheme node. This inference strength score is then used to look up the evaluation score of the conclusion statement node of the first inference (FIG. 15b), and so on through the argument graph until the final conclusion statement node is reached.

As will be understood, this is only one possible method of evaluation. Different methods can be devised, for example with different scoring systems or different calculation rules.

For example, the score generation function can be arranged to enable a user to select a numerical score for each free statement node the values of “1” and “0”, with 1 corresponding to absolute certainty that the statement is true and “0” absolute certainty that the statement is false. The same numerical scale is used for the evaluation scores and for the inference strength scores. Using a numerical score allows a greater degree of precision than using discrete scale such as True, False, Undetermined.

In this case, the scores can be interpreted as probabilities. A node score for a free statement node is a probability corresponding to the user's degree of belief that the statement is true. An evaluation score for an evaluated statement node is a calculated probability that the statement is true. An inference strength score for an argumentation scheme node is a calculated probability that the inference is strong.

The use of probabilities enables calculation methods from the probability calculus to be used in the evaluation function. In accordance with certain embodiments, the evaluation function calculation can be performed using conditional probability tables. In this case, the inference strength score for an argumentation scheme node is calculated from the node scores (for free statement nodes) and evaluation scores (for evaluated statement nodes) of the statement nodes connected to it by premise arcs and evidence arcs, and from a set of conditional probabilities. The evaluation score for a statement node is calculated from the inference strength scores of the argumentation scheme nodes connected to it by conclusion arcs, and from a set of conditional probabilities. The calculations are made using a conditional probability table. The rows of a conditional probability tables show all possible combinations of true/false or strong/weak of the nodes which affect the score of the node in question. The conditional probabilities in the tables embody the calculation rules of the evaluation function.

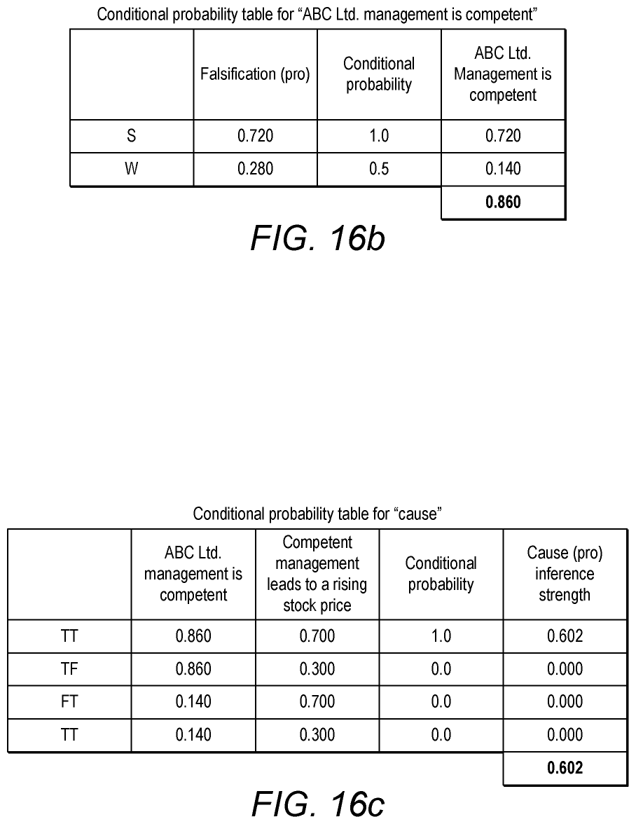

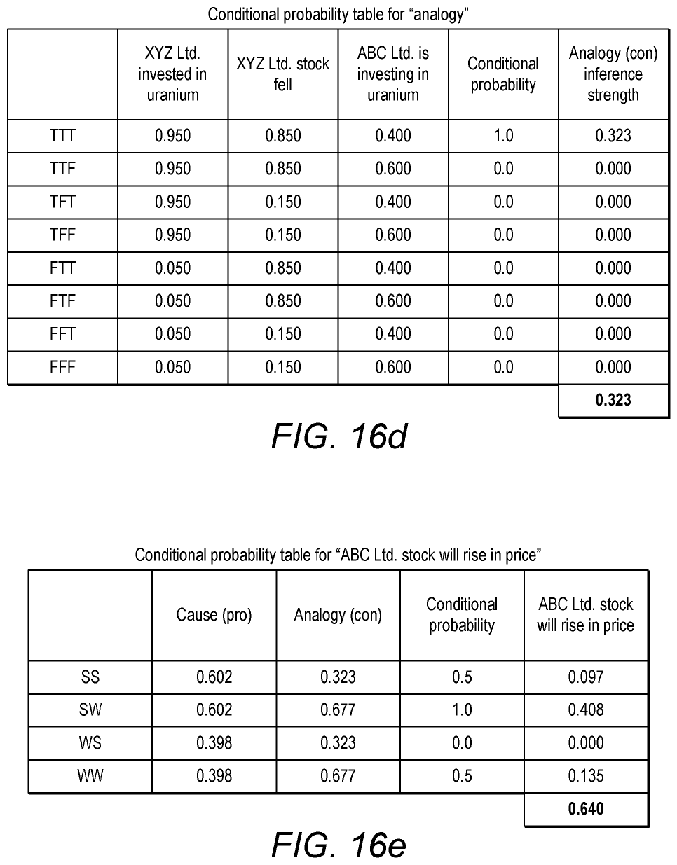

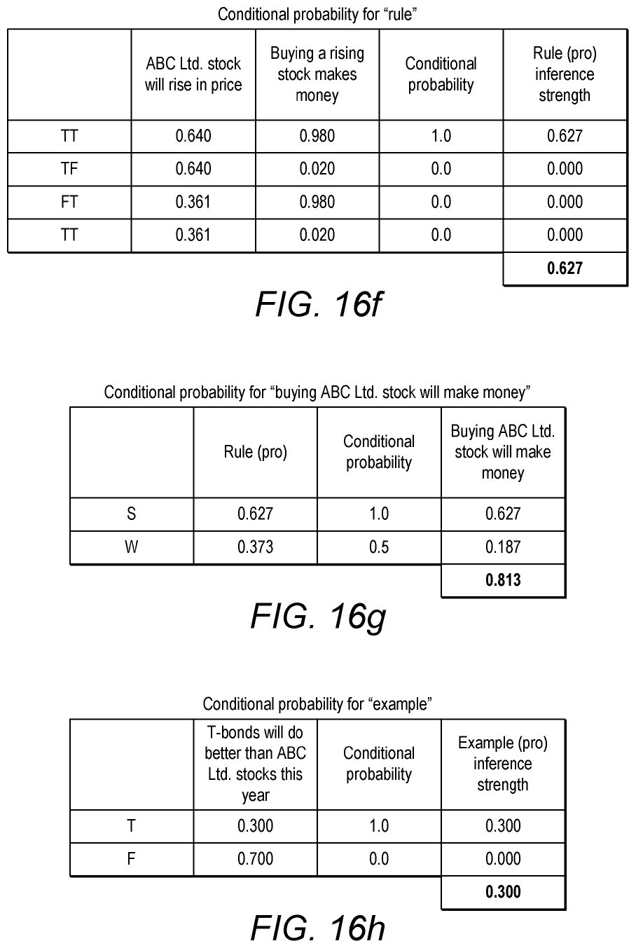

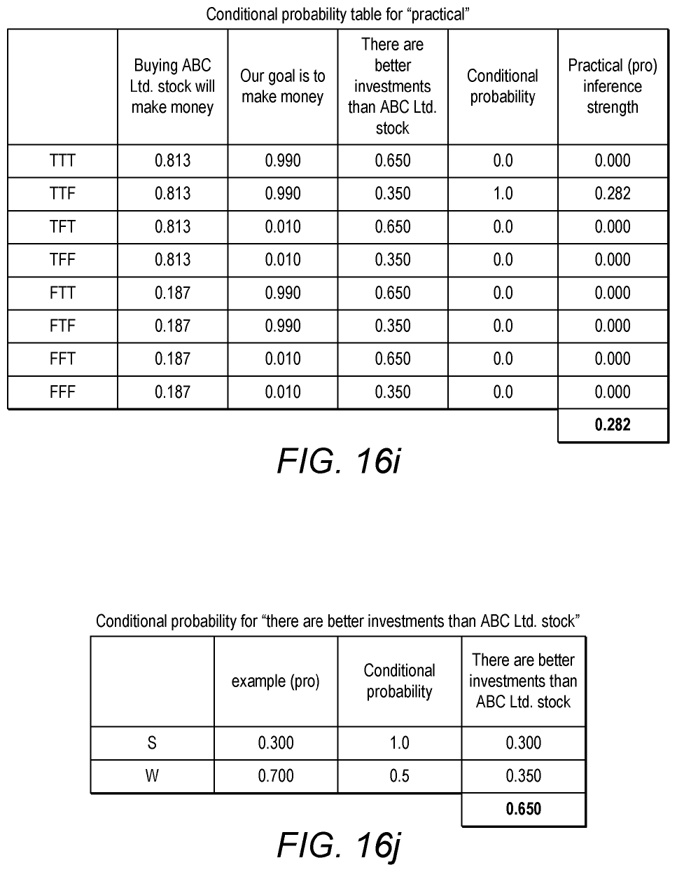

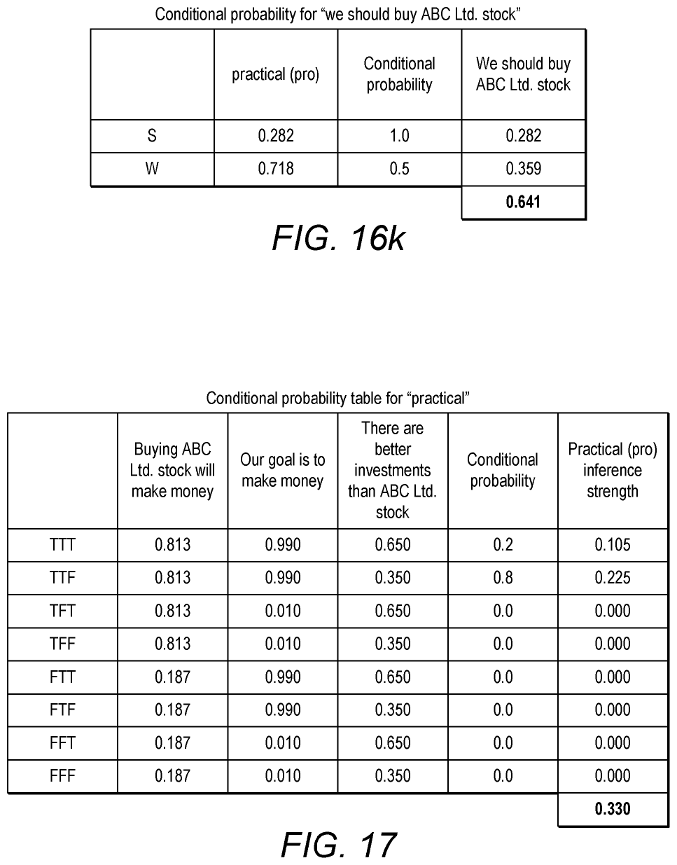

FIG. 16(a-k) shows an example of an evaluation function using conditional probability tables for the argument graph of FIG. 8. In this example, all probabilities have been rounded to 3 decimal places. The node scores of the free statement nodes have been chosen as follows: (P means probability)
Incompetent management leads to profit warnings. P=0.9
ABC Ltd. Has not issued a profit warning. P=0.8
Competent management leads to a rising stock price. P=0.7
XYZ Ltd. invested in uranium. P=0.95
XYZ. Ltd. stock fell. P=0.85
ABC Ltd. is investing in uranium. P=0.4
Buying a rising stock makes money. P=0.98
T-bonds will do better than ABC Ltd. stocks this year. P=0.3
Our goal is to make money. P=0.99

In this example the following rules are used:

For calculation of an inference strength score, conditional probability is 1.0 when all premise statement nodes are true and no weakening evidence node is true; otherwise 0.

For calculation of an evaluation score, conditional probability is: 1.0 when any pro inference is strong and all con inferences are weak; 0.0 when any con inference is strong and all pro inferences are weak; otherwise 0.5.

The probability of a statement being true is its node score or evaluation score. The probability of a statement being false is 1 minus its node score or evaluation score. The incoming statements of an argumentation scheme node are the statements whose statement nodes are connected to it by premise or evidence arcs, i.e. the statements that affect its inference strength score. The inference strength score for an argumentation scheme node is the product of its incoming statement probabilities and a conditional probability, summed over all permutations of these incoming statements being true or false.

For example, FIG. 16c shows the calculation table for the inference strength score of the “cause” argumentation scheme node. The first line of the table is the probability of the first premise being true (0.860) multiplied by the probability of the second premise being true (0.700) multiplied by a conditional probability (1.000). The second, third and fourth lines of the table are the product of the first and second premise node probabilities and a conditional probability in the cases where the first premise is true and the second premise is false, the first premise is false and the second premise is true, the first premise is false and the second premise is false, respectively. The inference strength score of the “cause” argumentation scheme node is the sum of these products.

The probability of an inference being strong is the inference strength score of its argumentation scheme node. The probability of an inference being weak is 1 minus the inference strength score of its argumentation scheme node. The incoming inferences of a statement node are the inferences for which it is the conclusion statement node, i.e. the inferences that affect its evaluation score. The evaluation score for a statement node is the product of its incoming inference probabilities and a conditional probability, summed over all permutations of these inferences being strong or weak.

For example, FIG. 16e shows the calculation table for the evaluation score of the statement node specified by “ABC Ltd. stock price will rise”. The first line of the table is the probability of the first incoming inference being strong (0.602) multiplied by the probability of the second incoming inference being strong (0.323) multiplied by a conditional probability (0.500). The second, third and fourth lines of the table are the product of the first and second incoming inference probabilities and a conditional probability in the cases where the first inference is strong and the second premise is weak, the first premise is weak and the second premise is strong, the first premise is weak and the second premise is weak, respectively. The evaluation score of the statement node specified by “ABC Ltd. stock price will rise” is the sum of these products.

### Evaluation—System-Wide Parameters

One disadvantage of the evaluation method shown in FIG. 16(a-k) is that the conditional probabilities used to calculate the inference strength scores are fixed values. This method treats all inferences as equal. If any inference has true premises, and no weakening evidence, then it will have a probability of being strong of 1.0. But in human reasoning, the different types of inference are not normally equally strong. It would be an advantage for the evaluation method to include a way to adjust the probability of each inference being strong, depending on what kind of inference it is.

In certain examples, the conditional probabilities in the tables used to calculate the inference strength scores of the argumentation scheme nodes can be modified. FIG. 17 shows an example in which the conditional probability of the case in which premises are true and weakening evidence is false is lowered from 1.0 to 0.8, and the conditional probability of the case in which premises are true and weakening evidence is true is raised from 0.0 to 0.2 (compared to FIG. 16i). This type of modification allows the probability of the inference being strong to be adjusted. This will then affect the probability of its conclusion statement.

This kind of modification can be made system-wide. The conditional probabilities used to calculate the inference strength score for a certain type of argumentation scheme node are set as a system-wide parameter. This can ensure that arguments employing the same argumentation scheme types are numerically evaluated in a consistent way, irrespective of the subject matter of the argument in question. Such examples can be used to provide a means for consistently evaluating the arguments associated with complex reasoning and decision-making allowing the arguments underpinning a piece of reasoning or a decision to be evaluated in a quantitative manner.

For example, a conditional probability of 0.5 (when premises true and no weakening evidence is true) can be set for the calculation of inference strength score of all “analogy” argumentation scheme nodes, thus limiting their maximum inference strength score to 0.5, unless there is strengthening evidence. The same conditional probability can be set to 0.8 for all “practical” argumentation scheme nodes (as shown in FIG. 17). This recognises that reasoning by analogy is generally a weaker type of reasoning than other types, such as practical reasoning. Using such system-wide parameters for conditional probabilities in the tables used to calculate the inference strength scores of the argumentation scheme nodes allows each type of inference to have the right amount of influence in the reasoning. These system-wide parameters are predetermined, fixed values, set by the system administrators. This removes the possibility of the user adjusting these parameters in an ad hoc way.

### Belief System and Coherence

In certain examples, score generation function provided by the interface is configured to permit a user to assign and edit a node score for all statement nodes in an argument graph—both for the evaluated statement nodes as well as the free statement nodes. The set of node scores for all statement nodes can be called the user's belief system. This is a representation of the user's beliefs concerning the subject matter of the argument graph.

One disadvantage of the evaluation method shown in FIG. 16(a-k) is that the conditional probabilities used to calculate the evaluation scores of the evaluated statement nodes are fixed values. In particular, the conditional probability used in the case in which all incoming inferences are weak, is set at a fixed value of 0.5. This conditional probability is a “default” value for the probability of a statement. When all incoming inferences are weak, the evaluation system will assign this default probability as the evaluation score of the statement node. But 0.5 may or may not be a suitable value, depending on what the statement is.

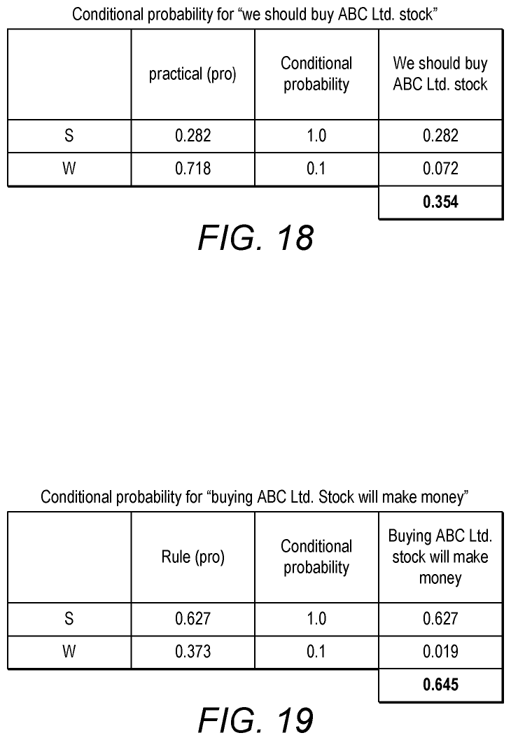

Optionally, this default probability can be replaced by the user-chosen node score for the statement node being evaluated which reflects the background knowledge and experience of the user as represented by their belief system. For example, the table shown in FIG. 18 calculates the probability of the statement “We should buy ABC Ltd. stock” in which the conditional probability in the case of the “practical” inference being weak is lowered from 0.5 to 0.1 (compared to FIG. 16k). In this example, the change might be done to reflect a preference not to buy stock unless the arguments to do so are strong. The change in the default probability lowers the evaluation score of the statement node, as desired.

In certain examples, the interface may be configured to use the evaluation scores of an argument graph to identify whether or not a user's belief system is coherent.

Having the user assign node scores for all statement nodes has a further benefit in that it allows an incoherence measure to be defined. For example, the incoherence of a statement node could be defined as the absolute difference between the node score and the evaluation score: i.e. abs(node score−evaluation score). If the incoherence is greater than a certain limit, then this indicates a problem. It means that the user's degree of belief in a statement is very different to the probability of the statement that is the consequence of the reasoning, which itself depends only on the user's belief system (plus the system-wide parameters)—in other words, the user's belief system is incoherent.

A coherent belief system could then be defined as one in which incoherence is lower than a certain limit at all statement nodes in the argument graph. This limit can be set system-wide. A reasonable person is rationally compelled to make their beliefs agree with their reasoning and to aim for a coherent belief system. If there is incoherence, the user can eliminate it by changing their belief system (i.e. changing node scores), or by changing the argument graph (i.e. adding more inferences or evidence statement nodes). In this way the evaluation system models the normal practice of reasoning. If a person accepts a piece of reasoning that leads to a conclusion they don't believe in, they either need to change their beliefs or come up with a counter-argument to defeat the reasoning.

For example, FIG. 19 shows a large difference between the default probability of 0.1 for the statement “Buying ABC Ltd. stock will make money” (which is equal to the node score chosen by the user) and the probability of 0.645 calculated by the evaluation method. This indicates that the user's belief system is incoherent. The user can repair this by changing their node score for this statement, or by making some change to the argument graph, for example finding an evidence statement node to weaken the “rule” inference.

As will be understood, this is only one possible method of calculating incoherence of a belief system. Different methods can be devised, for example with different mathematical functions operating on the probabilities, and different limit values. A measure of incoherence can be used to distinguish incoherent from coherent belief systems, and encourage the user to do further work within the system to eliminate incoherence, since coherence is a rational constraint on knowledge. When the user has achieved a coherent belief system, this is a representation of their mature point of view on the subject matter of the argument graph. It may be possible for different people to have different, coherent belief systems applying to the same argument graph. So, the belief systems defined using the argument graph serve as a way to distinguish and represent these points of view.

Description of Interface Display options

The interface can be arranged to display that graph data in any suitable way. For example, in examples in which arguments are represented in a single continuous graph space, the interface is typically provided with suitable graphical navigation controls to allow the display of “zoomed in” views showing particular argument graphs, or parts of particular argument graphs and to allow corresponding “zoomed out” views showing multiple argument graphs and how they are connected. In certain examples, the interface may be provided with navigation controls that allow a particular node, such as a statement node to be selected and further control enabling a user to specify a number of arcs, responsive to which the interface displays the selected node and all the nodes connected to it directly or via intermediate nodes up to the specified number of arcs distant.

The interface can be arranged to display the graph so that is has the optimal layout for the user to understand the argument. Optimal here means avoiding confusing patterns such as arcs crossing one another or nodes overlapping, and also being predictable, so that similar (i.e. graph isomorphic) argument graphs have the same layout. Calculating the optimal layout of a large graph is complicated, but this can be done by storing optimal layouts of smaller graphs and then arranging these together. For example, inference graphs usually have either one, two or three premise statement nodes and one conclusion statement node. These can be arranged using a convention so the layout is more predictable: if one premise statement node—place above the argumentation scheme node; if two premise statements nodes—place the second to the right of the first; if three premise statement nodes—place the third below the second; conclusion node is always below the argumentation scheme node. If all inference graphs with, say, 3 premises have the same predictable layout, the graph is easier to understand.

In larger argument graphs, the layout of the inference graphs that comprise the argument graph may have to be adjusted by the user to avoid confusion. But a successful layout can be stored, such that any new argument graph which is isomorphic to the stored argument graph layout is automatically arranged into this layout. In this way a library of successful layouts can be built up so that most new argument graphs do not have to be adjusted by the user.

On the interface, the graph data can be displayed in a two-dimensional view enabling a user to move the view of the graph data in X and Y directions. Alternatively, the graph data can be displayed in a three dimensional view enabling a user to the move the view of the graph data in X,Y and Z directions. The third dimension can be used, for example, to distinguish between scenario spaces. Alternatively, the graph may be displayed within a three-dimensional space by using virtual reality or augmented reality technology which is well-known in the art. In this type of three-dimensional view, the graph might appear as a three-dimensional object, or as a 2-dimensional object—like a display panel, but the graph appears to have a definite position in the three-dimensional space viewed by the user.

One possible application is to for a co-located group of people to use augmented reality technology to form a “heads up” interactive display of the graph occupying a definite position in the users' different fields of view, while they can still see and engage with each other, for example in a classroom setting. Another possible application is for a group of people located in different places to use virtual reality technology to share a virtual space, such as a classroom, within which the graph appears as an interactive object.

The representation of argument in a graphical way has important accessibility benefits for certain groups of users. In general, a graphical representation uses far fewer words to convey the same meaning compared to a traditional form such as an essay or a textbook. Also, responding to the argument by participating in the evaluation process, by adding new parts to the graph, or through automated testing, develops the users thinking skills but involves very little reading and writing. This makes the material much easier to grasp and to use for users with various disabilities such as dyslexia and cerebral palsy, and for pupils who are studying in a non-native language.

In some examples, the interface can be designed to display the graph such as to convey the maximum amount of information through a variety non-textual means to increase this accessibility benefit. For example, the node scores and evaluation scores may be shown using a palette of colours rather than numbers; the incoherence of a statement may be shown using a different visual means such as hatching instead of a text label or another colour; the inference strength scores may be shown by the length of a bar instead of a number or colour or hatching. FIG. 8, for example, shows colours used to indicate whether a conclusion arc is pro or con, eliminating the need to use a text label. Colours used to display the graph can be selected to enhance accessibility (e.g. the use of red and blue instead of red and green to enhance contrast for those suffering from the most common forms of colour blindness).

### Education Applications

In certain examples, the interface may be optimised for particular applications, for example education applications. In such examples, a teaching optimised interface may be provided with additional functionality such as a “lessonising” function. Such lessonising functions are adapted to automatically divide an argument graph down into predetermined parts. In one example, the lessoning function is adapted to present an argument graph as a series of consecutive views, wherein each view is of one of the inference graphs that makes up the argument graph. Such an arrangement enables a teacher to step through the component inferences of an argument, one inference at a time which is useful when teaching pupils. Typically, the inference graphs are presented in an order that corresponds to the order in which they appear in the argument graph. The lessonising function may also divide the argument graph into logical zones, such as the main argument, first counter argument, second counter argument and so on. The lessonising function allows the teacher to step through a first zone one inference at a time, and then step through a second zone one inference at a time and so on, until the whole argument graph is covered.

In certain such examples, the interface provides an annotation function enabling parts of the graph to be annotated with relevant material, for example factual knowledge, teaching comments, quotes, etc., that are not part of the argument graph structure, but are associated with nodes or inferences in the graph. This introduces this extra information in the right context for learning.

The annotated material may be public and therefore made accessible to anyone who has access to use the graph. Or the annotated material may be private and made accessible to a restricted readership. This allows, for example, a pupil to write study notes for herself, or a teacher to write a note to be read by their class.

In certain related embodiments, a pupil optimised interface may be provided that enables automated assessment of a pupil to be conducted. For example, the interface may be configured to present a passage of text comprising an expression of defeasible reasoning and the pupil optimised interface may be configured to enable a pupil to attempt to generate an argument graph, as described above, reflecting the expression of defeasible reasoning in the passage of text. The interface includes an assessment function adapted to compare the pupil's version of the argument graph with a pre-established version of the argument graph and generate an assessment score reflective of how closely the pupil's version of the argument graph corresponds with the pre-established version of the argument graph.

Alternatively or additionally, the pupil optimised interface may also be configured to present a single graph node or a plurality of graph nodes to the pupil to enable the pupil the attempt to connect these new nodes to an argument graph that the pupil has already studied. Alternatively or additionally, the pupil optimised interface may be configured to present the pupil with a multiple choice of new nodes to connect to an argument graph that the pupil has already studied. The interface includes an assessment function adapted to compare the pupil's modification of the argument graph with a pre-established modified version of the argument graph and generate an assessment score reflective of how closely the pupil's modification of the argument graph corresponds with the pre-established modified version of the argument graph.

Alternatively or additionally, the pupil optimised interface may also be configured to disassemble an argument graph that a pupil has already studied into its component nodes and arcs to enable the pupil to attempt to re-assemble the argument graph correctly.

In these and similar ways, the pupil optimised interface can test the skills of the pupil in terms of: analysis of reasoning, critical thinking, and memorisation of reasoning. These assessments can be automated therefore saving time and effort for the teacher.

In certain related embodiments, a pupil optimised interface may be provided that enables pupils to interact with an argument graph they have studied. The interface allows the pupil to assign and edit a node score for all statement nodes in the argument graph, as described above. The interface also allows the pupil to add further inference graphs and evidence statements to the argument graph. The pupil can then save their modifications such that their new version is stored in the database separately from the graph they have studied.

In this way the pupils can respond to the argument they have studied. They can disagree with premises, add counter arguments and strengthen or weaken existing inferences. Their modified argument graphs and evaluation scores then represent their belief systems and reasoning concerning the subject matter of the argument. Their work can then be compared with others or it can be assessed by a teacher. This interactive learning process can lead to faster and more effective learning. Since the pupils' modifications to the graph involve far less writing than traditional methods such as written answers to questions, or essay writing, it is much faster for pupils to compare their ideas and for teachers to assess their work.

Additionally, modifying an argument graph can be set as a task for a group of pupils. Organising a group of people to write a traditional essay or report in long form prose is very complicated. It is much easier for a group to modify a graph, since changes to one part of the graph can be made independently of changes to other parts.

### Profiling

In certain examples, the interface may be configured for generating user profiling data. For example, a number of users may be presented with the same argument graph or series of argument graphs. The interface requires that the user modifies the node scores for the statement nodes; these node scores are stored as the user's belief system, as described above.

All or part of the belief system for individual users is communicated back from the interface to a profiling function provided with the application. The profiling application is arranged to generate user profiling data, which for example, generates lists of users with similar views.

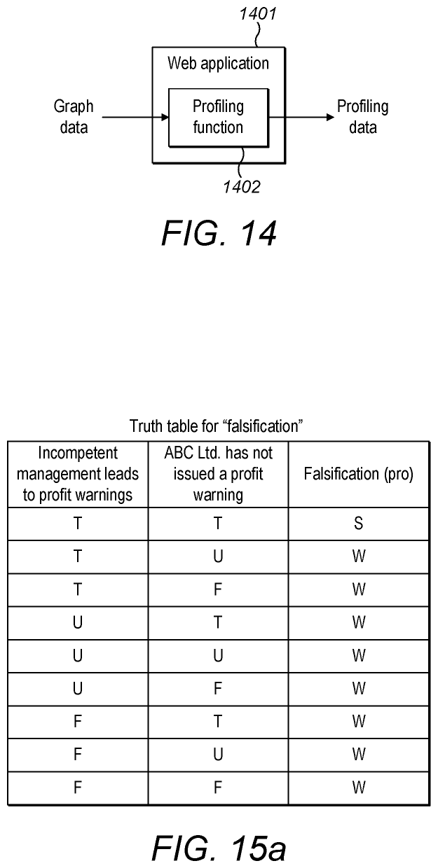

FIG. 14 provides a schematic diagram of a modified web application 1401. The modified web application corresponds to the web application described with reference to FIG. 1 but further includes a profiling function 1402. The profiling function is configured to receive belief system data generated as described above, along with user identification data (entered by individual users via the interface for example) and to associate belief system data with users to generate profiling data. For example, the profiling data could comprise data tables in which node scores from a user's belief systems associated with conclusion statement nodes from various different argument graphs are collated. Such profiling data can be used to identify correlations between different users more effectively, for example, than with conventional canvassing techniques such as questionnaires. In this way, beliefs of individual users, which might not be captured using conventional marketing techniques, can be captured and quantified and used, for example, to segment users into groups for, for example, targeted marketing. Profiling data may also be correlated with behaviour outside of the computer system, for example, which brand is selected from a choice of brands. This acts as a confirmation of the usefulness of the profiling technique. Also, since the profiling data represents the beliefs of the users, the profiling data gives an insight into the beliefs and motivations of people exhibiting such behaviour.

In some embodiments the profiling function may be provided in a separate application to the web application, for example a separate web application running on the same or different application server or a stand-alone client application running on a client device.

### Chatbot Assistant

In certain examples, the graph interface program can be provided with a chatbot assistant—chatbot technology is well known in the art. The chatbot can answer questions from the users about the argument or it can ask questions of the user and then respond to the answers. For example, if a pupil is studying a lessonised form of the graph and does not understand one step of the argument, the pupil can ask a question about it.

A chatbot has to be trained using examples from human interactions. The process has to begin with human experts who answer or ask questions, while the chatbot learns. Normally, it is very difficult to train a chatbot to answer questions about argumentative material in the form of an essay or a textbook, since the possible scope of the questions is very large—it is the whole essay or book. But when the chatbot is learning from interactions that take place as part of a graph-based activity, such as a lessonised graph, the chatbot can learn quickly because questions can be related to the position in the graph where the question arose, so they have a limited possible scope. This quick learning can dramatically lower the amount of customer support required for applications such as teaching.

### Automated Document Writing Application

In certain applications, argument graph data generated as described above can be used by a document writing application. For example, a document writing application may take as input an argument graph as described above and convert the graphical representation of the argument into long form text: i.e. into normal prose.

The argument graph data is comprised of individual inference graphs, which are connected together by sharing statement nodes. The task of conversion into long form text is therefore a task of converting inference graphs into long form text and then joining this text in a meaningful way.

One method for converting an inference graph into long form text is for the computer system to store text snippets that are specific to each type of argumentation scheme and which connect the text specifying the statement nodes together to form a meaningful paragraph. For example, for the “expert opinion” inference graph shown in FIG. 6, a meaningful paragraph could be formed as follows (text snippets shown in capitals, text specifying the statement nodes shown in lower case):

“Dr Smith says the x-ray image shows a cancer. Dr Smith is an expert in cancer. SINCE THIS IS AN EXPERT'S OPINION, IT SHOULD BE TRUSTED. SO, IT IS LIKELY THAT the x-ray image shows a cancer. ON THE OTHER HAND, Dr Smith is often drunk at work. THIS MEANS THE EXPERT'S OPINION IS UNRELIABLE. SO, IT IS UNLIKELY THAT the x-ray image shows a cancer.”

This procedure can be followed for all the argumentation scheme types and each one will use its specific text snippets. Some of the text snippets are used to mention evidence pertaining to specific critical questions. In the example above, “THIS MEANS THE EXPERT'S OPINION IS UNRELIABLE” is used because the evidence statement arc is pointed at the critical question concerning reliability. Multiple sets of text snippets can be stored and used, so that the style of the resulting document is varied and not stilted.

In a similar way, text snippets can be used to move from one inference to another in an argument graph. For example, if the conclusion of the inference of FIG. 6 is a premise for a further inference, the next paragraph of the long form text could start with:

“SINCE IT IS UNLIKELY THAT the x-ray image shows a cancer, . . . ”

And this is followed by the rest of the next inference in long form text.

This function to produce an equivalent of the argument graph in long form text is useful in many applications in which a textual, rather than a graphical, form of the argument is required. Examples of this could be legal documents, essays to be submitted for marking, publicly available government documents, and so on. Once it is produced, the long from text of the argument graph can be exported and shared in a common document format such as a rich text document so that readers do not need access to the graph interface program to view it.

Apart from the convenience of having a document written automatically, this function also provides a means to author important, argumentative documents more reliably. It is much easier to inspect and check an argument in the form of a graph than in long form. When an important document, such as a legal opinion, needs to be written, the reasoning can be created using the graph interface program and checked. When it is approved the document is written automatically.

This function is also an alternative means of teaching using the argument graph data. If, for example, differences in learning style between pupils make some pupils reluctant to learn from the graphical presentation of an argument graph, it can be presented to them in long from text. The information contained is the same.

### Decision-Making Application

Most reasoning in organisations is about taking decisions. Decision-making is a reasoning process, in which values have been placed on certain outcomes which can be represented using a value function. Values are generally set by leadership of the organisation, for example, profit targets for a commercial company, vote share for a political party, and so on.

In accordance with certain embodiments of the invention, to accommodate this, the interface includes a value function that enables a user to specify values for the statement nodes in the argument graph. Statements that describe desirable or undesirable states-of-affairs are then given a value by the user. The evaluation scores for the statement nodes show the probability of these states-of-affairs happening. The value function then reports the probability of each of the statements which have a value. For example, the statement “Profit increases by £10m” might be given a high value by the leadership, and the evaluation score shows this statement has a probability of 30%. Various metrics can be devised to calculate an aggregate value, for example the values for statements can be multiplied by their probabilities and summed up. This information can help the decision-maker decide whether anything needs to change, so the valued outcomes have a higher probability.

Scenario spaces are especially useful to help decision-making. If a decision has to be made between two options, such as deciding between Brexit and no Brexit, then those options can be set up as alternative possible-future scenario spaces. Then a similar argument graph can be constructed within both scenario spaces. The scenario spaces ensure that otherwise identical statements are distinguished from one another—so statement nodes specified by “GDP will rise” can have different evaluation scores within the two scenarios. The decision is then made by applying the value function to the two scenarios and comparing the results to see which has a higher aggregate score. A scenario in which high value statement nodes have high evaluation scores (i.e. high probability) should be chosen over one in which they have low evaluation scores. For example if the statement “GDP will rise” is given a high value, and this statement has a higher probability in the “no Brexit” scenario, then the decision should be to avoid Brexit—all other things being equal. Decision-making is normally a group process in an organisation. As discussed above, it is much easier for a group to work together to modify a graph than to author a prose document such as a recommendation report. Graphs based decision making is especially suitable for group decision-making.

Terms used in the description above will be well understood by the skilled person. The following table provides a general glossary for some of the terms used.

| Graph term | Represents . . . |
|---|---|
| Argument graph | An argument |
| Inference graph | A defeasible inference |
| Premise statement node | Premise statement |
| Argumentation scheme node | Argumentation scheme |
| Conclusion statement node | Conclusion statement |
| Evidence statement node | Evidence statement |
| Premise arc | the logical relation of a statement being a premise of an |
| | inference |
| Conclusion arc | the logical relation of a statement being a conclusion of |
| | an inference |
| Evidence arc | the logical relation of a statement strengthening or |
| | weakening (defeating) an inference. |
| . . . depicted by additional | Critical questions |
| labelling on the argumentation | |
| scheme node in question | |
| Scenario space | Argument context |
| Node score | User-defined truth-value for a statement node |
| Evaluation score | Calculated truth-value for a statement node |
| Inference strength score | Inference strength for an argumentation scheme node |
| Belief system | User's point of view on the subject matter of the argument |
| | graph |
| Incoherence | Measures incoherence of a user's belief system |
| Term | Explanation |
| Argument | An argument is a series of one or more connected |
| | inferences leading to a final conclusion statement. |
| Argument graph | Each argument graph comprises one or more connected |
| | inference graphs. |
| Inference graph | An inference graph represents a defeasible inference. An |
| | inference graph comprises at least one premise |
| | statement, one argumentation scheme and one |
| | conclusion statement. |
| Pro, con | An inference is “pro” if it tends to make a conclusion true |
| | or “con” if it tends to make the conclusion false. |
| Argumentation scheme | Each argumentation scheme corresponds to a type of |
| | inference that humans use in reasoning. Argumentation |
| | schemes capture common sense patterns of reasoning |
| | that humans use in everyday discourse. |
| Argumentation scheme | The argumentation scheme template defines the format |
| template | of the inference graph for that particular type of |
| | argumentation scheme. |
| Evidence statement node | . . . evidence statement nodes that may strengthen or |
| | weaken the inference |
| Critical questions | The critical questions are a help to the user, to think |
| | about how the inference may be modified by further |
| | evidence. |
| Defining a statement | . . . the statement “Dr. Smith is often drunk at work.” |
| Defining a statement node | . . . the statement node specifying “Dr. Smith is often drunk |
| | at work.” |
| Rebuttal | This situation where a pro inference and a con inference |
| | have the same conclusion statement is called a rebuttal. |
| Graph space | The interface enables a user to generate different |
| | argument graphs on a single continuous graph space. |
| Argument interconnecting arcs | The argument interconnecting arcs are the arcs that link |
| | to this [shared] statement node in the several different |
| | argument graphs. |
| Argument context | . . . contexts can be of several types, including |
| | counterfactual past, possible future, fiction, thought |
| | experiment, and so on. |
| Scenario space | Nodes of inference graphs and argument graphs within |
| | such scenario spaces are affected by the context to which |
| | that scenario space relates and nodes of inference |
| | graphs and argument graphs outside of that scenario |
| | space are not. |
| Free statement node | [a] statement node that is not the conclusion statement |
| | node of any inference graph comprising the argument |
| | graph. |
| Evaluated statement node | [a] statement node that is a conclusion statement of any |
| | inference graph comprising the argument graph. |
| Score generation function | . . . score generation function that is configured to permit a |
| | user to edit the node score for each [free] statement node |
| Evaluation function | An evaluation function calculates an inference strength |
| | score for each argumentation scheme node. The |
| | evaluation function also calculates an evaluation score for |
| | each [evaluated] statement node |
| Overall evaluation score | The evaluation score for the final conclusion statement |
| | node is the overall evaluation score. |
| Probability of a statement | The probability of a statement being true is its node score |
| | or evaluation score. The probability of a statement being |
| | false is 1 minus its node score or evaluation score. |
| Probability of an inference | The probability of an inference being strong is the |
| | inference strength score of its argumentation scheme |
| | node. The probability of an inference being weak is 1 |
| | minus the inference strength score of its argumentation |
| | scheme node. |
| Incoming inferences | The incoming inferences of a statement node are the |
| | inferences whose graphs are connected to it by |
| | conclusion arcs, i.e. the inferences that affect its |
| | evaluation score. |
| Incoming statements | The incoming statements of an argumentation scheme |
| | node are the statements whose statement nodes are |
| | connected to it by premise or evidence arcs, i.e. the |
| | statements that affect its inference strength score |
| Belief system | The set of node scores for all statement nodes can be |
| | called the user's belief system. This is a representation of |
| | the user's beliefs concerning the subject matter of the |
| | argument graph. |
| Default probability of a | . . . the conditional probability used in the case in which all |
| statement | incoming inferences are weak, is set at a fixed value of |
| | 0.5. This conditional probability is a “default” value for the |
| | probability of a statement. When all incoming inferences |
| | are weak, the evaluation system will assign this default |
| | probability as the evaluation score of the statement node. |
| Incoherence | If the incoherence is greater than a certain limit, then this |
| | indicates a problem. It means that the user's degree of |
| | belief in a statement is very different to the probability of |
| | the statement that is the consequence of the reasoning, |
| | which itself depends only on the user's belief system |
| | (plus the system-wide parameters)—in other words, the |
| | user's belief system is incoherent. |
| Coherent belief system | A coherent belief system is one in which ncoherence is |
| | lower than a certain limit at all statement nodes in the |
| | argument graph. |

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A computer system for enabling a user to interact with graphical representations of defeasible reasoning, said system comprising:
a server device on which is running an application;
memory storage on which is stored graph data defining a plurality of argument graphs, each argument graph comprising a plurality of nodes, said plurality of nodes comprising:
at least a first premise statement node, connected via a first arc to
at least a first argumentation scheme node, connected via a second arc to
at least a first conclusion statement node, and optionally one or more evidence statement nodes connected via one or more arcs to the argumentation scheme node, wherein
said system further comprises at least one client device, wherein
said application is operable to access the graph data and communicate at least part of the graph data to the client device.

2. A computer system according to claim 1, wherein nodes of at least some argument graphs are associated with at least one scenario space, each scenario space associated with an argument context.

3. A computer system according to claim 2, wherein the graph data provides a single continuous graph space with which the plurality of argument graphs are associated.

4. A computer system according to claim 1, wherein the application controls the client device to provide an interface configured to display argument graphs of the graph data enabling a user to view the graph data and modify the graph data by editing the graph data or generating new graph data.

5. A computer system according to claim 4, wherein the interface is arranged to communicate modified graph data to the application which is arranged to store the modified graph data in the memory storage.

6. A computer system according to claim 4, wherein the interface is configured to enable a user to modify the graph data by adding evidence statement nodes to an argument graph, said evidence statement nodes connected via an arc to at least one argumentation scheme node of the argument graph.

7. A computer system according to claim 4, wherein the interface is configured to display the argument graphs on a display space corresponding to the graph space such that scenario spaces are displayed in different regions of the graph space, and nodes associated with a scenario space are displayed within that scenario space.

8. A computer system according to claim 1, wherein the argument graphs are interconnected via argument interconnecting arcs.

9. A computer system according to claim 4, wherein the interface comprises a deduplication function configured to
receive from a user new statement node data corresponding to a new premise statement node or a new conclusion node data;
compare the new statement node data with statement node data of the graph data, and
prevent the generation of new statement node data to the graph data in the event of a match.

10. A computer system according to claim 4, wherein for each argument graph all the free statement nodes are associated with a node score such that an evaluation score can be generated for each evaluated statement node and an inference strength score can be generated for each argumentation scheme node, based on the node scores.

11. A computer system according to claim 10, wherein the node scores of any statement node can be amended by a user via the interface to generate locally on the client device evaluation scores for evaluated statement nodes specific to the user.

12. A computer system according to claim 10, wherein the inference strength scores of argumentation scheme nodes are generated based on predetermined fixed values that depend on the type of argumentation scheme, combined with the node scores (for free statement nodes) and evaluation scores (for evaluated statement nodes) of the statement nodes connected to the argumentation scheme node by premise arcs and evidence arcs.

13. A computer system according to claim 10, wherein node scores, evaluation scores and inference strength scores are interpreted as probabilities, and the evaluation scores and inference strength scores are calculated using conditional probability tables.

14. A computer system according to claim 11, wherein an incoherence measure can be generated from the node scores and evaluation scores of statement nodes, which can be used to generate a “coherent” or “incoherent” result for the user's belief system.

15. (canceled)

16. (canceled)

17. (canceled)

18. (canceled)

19. A computer system according to claim 4, wherein argument graphs comprise at least one inference graph, each inference graph comprising at least a first premise statement node, connected via a first arc to at least a first argumentation scheme node, connected via a second arc to at least a first conclusion statement node, said interface further comprising a lessonising function configured to divide argument graphs comprising multiple inference graphs into one or more inference graphs and generate views of the argument graph in which one or more of the inference graphs are sequentially displayed.

20. A computer system according to claim 19, wherein the interface includes a chatbot which provides an interactive communication service to the user during the sequential display of the inference graphs.

21. A computer system according to claim 19, wherein the interface is configured to allow the user to learn interactively by changing node scores and by adding nodes to the argument graph and to store the results in the database.

22. A computer system according to claim 4, wherein the interface is configured to provide an annotation function arranged to enable a user to annotate argument graphs displayed on the interface.

23. A computer system according to claim 4, wherein the interface is configured to enable automated assessments of a user to be conducted.

24. A computer system according to claim 4, wherein the web application further comprises a document writing application function configured to automatically generate a prose form of an argument represented by an argument graph.

25. (canceled)

26. An application for use in a computer system for enabling a user to interact with graphical representations of defeasible reasoning, said system comprising:
a server device on which is running an application;
memory storage on which is stored graph data defining a plurality of argument graphs, each argument graph comprising a plurality of nodes, said plurality of nodes comprising:
at least a first premise statement node, connected via a first arc to
at least a first argumentation scheme node, connected via a second arc to
at least a first conclusion statement node, and optionally one or more evidence statement nodes connected via one or more arcs to the argumentation scheme node, wherein said system further comprises at least one client device, said application operable to access the graph data and communicate at least part of the graph data to the client device.
